(19) United States
(12) Patent Application Publication
(10) Pub. No.: US 2018/0149468 A1
(43) Pub. Date: May 31, 2018

(54) TRUE HETERODYNE SPECTRALLY CONTROLLED INTERFEROMETRY

(71) Applicant: APRE INSTRUMENTS, LLC, Tuson, AZ (US)

(72) Inventor: ARTUR OLSZAK, Tucson, AZ (US)

(73) Assignee: APRE INSTRUMENTS, LLC, Tucson, AZ (US)

(21) Appl. No.: 15/825,219

(22) Filed: Nov. 29, 2017

Related U.S. Application Data
(60) Provisional application No. 62/427,980, filed on Nov. 30, 2016.

(51) Int. Cl. G01B 9/04; G01B 9/02; G01B 11/25; G01J 9/02

(52) U.S. Cl. CPC G01B 9/04; G01B 9/02007; G01B 9/02004; G01J 2009/0292; G01J 9/02; G01B 2290/35; G01B 11/2527

(57) ABSTRACT

Heterodyne spectrally controlled interferometry is performed by combining a delay line in Twyman-Green configuration with a Fizeau interferometer. By splitting a white-light beam in the delay line and introducing a time delay in one of the resulting beams, the delay line produces a recombined output beam with a sinusoidally modulated spectrum. By introducing a frequency shift in one of the beams in the delay line, the output beam is also continuously phase shifted in the spectral domain in a time-varying fashion, as required for heterodyne SCI.

### RELATED APPLICATIONS

This application is based on and claims the priority of U.S. Provisional Application No. 62/427,980, filed Nov. 30, 2016, hereby incorporated by reference in its entirety.

### BACKGROUND OF THE INVENTION

### Field of the Invention

This invention relates in general to the field of interferometry and, in particular, to a novel spectrally controllable light source for performing true heterodyne spectrally controlled interferometry.

### Description of the Prior Art

Spectrally controlled interferometry (“SCI”) is a recently developed interferometric technique that allows implementation of white light interferometry (“WLI”) measurement schemes in common-path interferometers. See U.S. Pat. No. 8,422,026, U.S. Pat. No. 8,810,884 and U.S. Pat. No. 8,675,205, all hereby incorporated by reference. WLI is characterized by the absence of coherent noise because of the light's short coherence length, typically on the order of a few micrometers. High-coherence units such as laser interferometers, on the other hand, are prone to reduced measurement accuracy due noise produced by dust and other contamination, diffraction on rough surfaces, etc.

Despite these difficulties, laser interferometry is extremely popular and useful because it allows the use of common-path interferometer designs—a particular class of devices in which most of the errors introduced by the optical system cancel out. This allows the manufacture of less expensive and more accurate instruments. High-coherence interferometry is also described as producing a non-localized interference pattern because the interference of beams occurs over a large volume of space, which is an advantage in setting up the measurement apparatus. The most commonly used design is the Fizeau interferometer.

WLI is immune to the problems of laser interferometers but requires careful balancing of the optical path difference between the test and reference arm of the interferometer (OPD) so that interference can take place in the measurement space (i.e., within the coherence length of the light). Such arrangements can be complex and prevent the use of common-path interferometers, therefore forfeiting the above-described advantages. WLI produces localized interference because it is visible only in a limited space around zero OPD.

SCI successfully combines both approaches and provides the advantages of both common-path interferometry and WLI. SCI produces localized interference in an unbalanced OPD interferometer and thus allows, for example, the use of a Fizeau interferometer in WLI mode, thus eliminating the problem of coherent noise. Therefore, one of the major advantages of SCI is that existing instrumentation can be adapted to its modality of operation by replacing only the laser light source with one capable of proper spectral modulation. Different interferometric techniques can be carried out by manipulating only the spectral properties of such light source. See, for example, the time-multiplexed SCI approach described in co-owned U.S. Pat. No. 9,581,428.

Heterodyne interferometry is one of the most precise methods of phase measurement. Its precision can be orders of magnitude better than with conventional phase-shifting interferometry, but it requires laser illumination. Therefore, it is susceptible to the same problems of conventional phase-shifting interferometers; that is, coherent noise and multiple interference. Co-owned U.S. Pat. No. 9,618,320 teaches an approach whereby heterodyne measurement methods are utilized and their related precision is achieved by modulating the light produced by a spectrally controlled source to introduce a time-varying phase shift in the spectral distribution. The present invention teaches a light source that enables the practicing of true heterodyne interferometry by modulating frequency-shifted beams according to SCI principles.

### SUMMARY OF THE INVENTION

The invention lies in the general idea of combining equal spectrally modulated beams where one of the beams has been frequency shifted to form a heterodyne wavefront, thereby providing the spectral modulation required for SCI and the heterodyne frequency required for heterodyne interferometry.

Alternatively, the same result can be achieved by spectrally modulating the combination of two equal but frequency shifted beams, it being understood that the order of spectral modulation and frequency shifting is inconsequential to the resulting heterodyne wavefront.

The concept of the invention is embodied by optically coupling a white-light source with a delay line that splits the light and introduces a time delay in one of the resulting beams, thereby yielding a recombined output beam with a sinusoidally modulated spectrum. By introducing a frequency shift in one of the beams in the delay line, the output beam is also continuously phase shifted in the spectral domain in a time-varying fashion, as required for heterodyne SCI. The delay line is preferably implemented with a Twyman-Green interferometer configuration. The frequency shift is carried out with an acousto-optic modulator inserted in one of the interferometer's arms.

Various other advantages will become clear from the description of the invention in the specification that follows and from the novel features particularly pointed out in the appended claims. Therefore, this invention includes the features hereinafter illustrated in the drawings, fully described in the detailed description of the preferred embodiments and particularly pointed out in the claims, but such drawings and description disclose only some of the various ways in which the invention may be practiced.

### BRIEF DESCRIPTION OF THE DRAWINGS

FIG. 1 illustrates the effects of spectral-modulation phase changes on the phase of the resulting interference fringes. The graphs on the left side of the figure show three different modulations of the spectrum with respective phases of −π/2, 0, and +π/2. The graphs on the right side illustrate the effects of these phase changes on the corresponding interference fringes, showing that the phase of the fringes follows the changes of phase in the spectral domain. The dotted lines show the respective unchanged envelopes of interference fringes.

FIG. 2 illustrates schematically a delay line in the form of a Twyman-Green interferometer.

FIG. 3 illustrates the delay line of FIG. 2 with an acousto-optic modulator inserted in one arm of the interferometer to induce an optical frequency shift according to the invention.

FIG. 4 is a schematic representation of an interferometric set up for practicing heterodyne spectrally controlled interferometry according to the invention.

### DETAILED DESCRIPTION OF THE INVENTION

As used in this disclosure, “white light” is intended to refer to any broadband light of the type used in the art of white-light interferometry, typically having a bandwidth in the order of many nanometers. “Monochromatic” light, on the other hand, is intended to refer to any high-coherence narrowband light capable of producing high-contrast interference fringes within the entire measurement space of the particular apparatus utilizing such light as a source. Light “irradiance” and “intensity” are used interchangeably, as normally done in the art, though it is recognized that the former technically refers to light received at a detector and the latter to light emitted by a source. A source is defined as “temporally coherent” or “coherent” if, at any given time, interference fringes can be detected within the measurement space of the interferometric apparatus used to implement SCI. The term “extended” refers to any spatially incoherent light source, as contrasted to a spatially coherent source, such as a point source generated by a focused laser beam. “Channeled spectrum” refers to the sinusoidally modulated spectrum produced by a broadband light passed through a delay line. With reference to light in general, the terms “frequency” and “wavelength” are used alternatively, as commonly done in the art, because of their well known inverse relationship. “Optical path difference” or “OPD” and “time delay” are used alternatively because of their space/time relationship in interferometry. As normally done in the art with reference to interferometric apparatus, “optical path difference” and “OPD” are also used to refer to the difference between the lengths of the optical paths of the test and reference arms of the apparatus. Similarly, “sine” and “cosine,” as well as related terms, are used alternatively unless specifically indicated otherwise.

The terms “modulate” and “modulation” are used in connection with a light source in the broadest sense to include any alteration of the frequency distribution, amplitude distribution or phase distribution of energy produced by the light source, and to also include the synthesis by any means of a light signal having a desired frequency, amplitude or phase distribution. When used in connection with interference fringes, the term “modulation” refers to the fringe envelope. In the case of spectrally-controlled or multiple-wavelength sources, “localized fringes” is intended to mean unambiguously identifiable fringe patterns formed at predetermined distances from the reference surface. Localized fringes are described as positioned at the surfaces from which they are produced to illustrate how they relate to those surfaces and surface shapes that produce them; however, it is to be understood that physically such localized fringes are only virtual fringes and that actual fringes are in fact formed in measurement space only at the surface of a detector. Also, the phrase “producing localized fringes at a predetermined position in space” and related expressions are used for convenience, but it is understood that the precise intended meaning is “producing an interferometric environment whereby unambiguously identifiable fringe patterns are produced when a test surface is placed at a predetermined position in space” relative to a reference surface. The terms “fringes” and “fringe patterns” are used interchangeably within the meaning normally accorded to them in the art. Finally, the generic term “interferometry” and related terms should be construed broadly as used in the art and not limited to shape measurements using an imaging interferometer. As such, interferometry is intended to include, without limitation, the measurement of changes in the position of an object, or of thickness of optical elements, using any known interferometric technique, and therefore it should not limited to shape measurements using an imaging interferometer. Finally, the term “spectrally controllable light source” is intended to mean any light source capable of spectral modulation, whether the source is a single-component spectrally controllable source, such as currently available lasers capable of spectral modulation, or a multi-component source, such as a source that includes a broadband source and a modulator as separate components.

Heterodyne interferometry is typically associated with an interferometric measurement setup where the two interfering beams have slightly different optical frequencies. Accordingly, “heterodyne wavefront” or “heterodyne beam” is used herein to indicate a wavefront composed of beams having different optical frequencies. The resulting interference fringes are not stationary in time, but oscillate at a rate equal to the difference in the optical frequencies of the two beams (referred to in the art as heterodyne frequency). The heterodyne interferometric signal carries information about the optical path difference (OPD) between the beams and can be used for its measurement. The main advantage of such arrangement is that the heterodyne frequency can be isolated with very high fidelity and its phase can be analyzed with a high degree of accuracy. This enables interferometric measurements with a precision that is orders of magnitude greater than that obtained with conventional phase shifting interferometry (PSI). See F. Zernike, “A Precision Method for Measuring Small Phase Differences,” J. Opt. Soc. Am. 40:326-328 (1950).

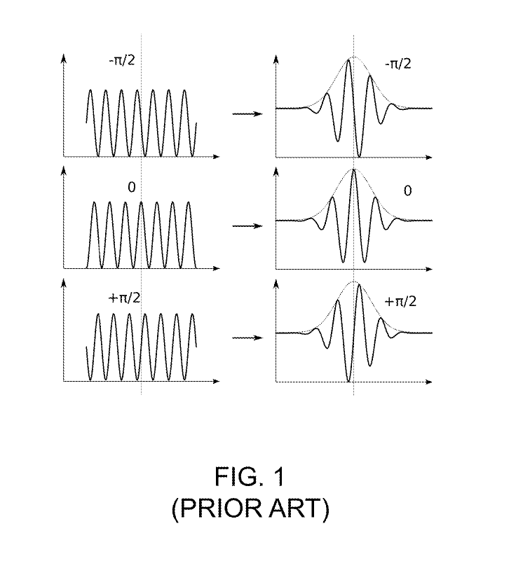

As described in U.S. Pat. No. 8,422,026, one of the properties of SCI is the ability to manipulate the location of the interference fringes by changing the period of sinusoidal modulation of the source's spectrum. Further, as illustrated in FIG. 1 and disclosed in U.S. Pat. No. 9,918,320, changes in the phase of the spectral modulation produce corresponding changes in the phase of the interference fringes without shifting the peak of the modulation envelope. For example, the graphs on the left side of the figure show three different modulations of the spectrum with respective phases −π/2, 0, and +π/2. The right side shows the effects of these phase changes on the interference fringes; namely, the phase of the fringes follows the changes of phase in the spectral domain with corresponding shifts of the modulation that do not affect the spatial position of the peak of the modulation envelope (shown by the dotted lines). As taught in U.S. Pat. No. 9,918,320, this property can be used to implement a heterodyne detection scheme in spectrally controlled interferometry with attendant advantages in a number of technical and scientific applications.

In a conventional two-beam heterodyne interferometer, the two beams have slightly different optical frequencies, v₁ and v₂. The resulting irradiance on the detector is described generally by the equations below, where for clarity the heterodyne term with frequency v₁+v₂ has been omitted because outside the detection range of detectors suitable to practice the invention,

I(t)=∫0^{+∞}|E₁(v)E*₂(v)e^{-2πiτv}e^{-2πiΔvt}|dv=E₁²+E₂²+2|E₁E*₂|cos(−2π(τv̅+Δvt+ψ)) (1)

and

v=c/λ. (2)

where the indices 1 and 2 denote the two interfering heterodyne beams, I is intensity, t is time, v=(v₁+v₂)/2 is the mean optical frequency, Δv=(v₁−v₂)/2 is the difference in optical frequencies of the two beams, E is the complex amplitude of the light, c is the speed of light, λ is its wavelength, τ is the time delay between the reference and object beams corresponding to the OPD, ψ is the relative phase difference between the beams, and * denotes the complex conjugate.

The irradiance must be registered by a detector that is fast enough to capture the variations of the signal with time; accordingly, the heterodyne frequency must be chosen to match detector capabilities. The phase of the heterodyne signal is related to the OPD present in the interferometer and, by analyzing it, it is possible to gain information about its value. Equation (1) is the basis of operation of conventional heterodyne interferometry. After simplifications based on the reasonable assumption that E is the same for both the 1 and 2 beams, the combination of the terms related to E in Equation (1) yields the form,

I(t)=0.5I(1+A cos(−2π(τv̅+Δvt+ψ))), (3)

where I is the mean beam intensity, and A is the normalized amplitude of the interferometric fringes.

Considering the apparatus normally used for heterodyne interferometry modified only with a source capable of operation using SCI principles (such as a light with a spectrum that is modulated sinusoidally, for example), U.S. Pat. No. 8,422,026 teaches (in Equation 11, expressed in a different form in terms of Fourier Transforms that the instantaneous intensity is described by the equation

$$I ( t ) = 0.5 I ( 1 + A cos ( - 2 π ( ϕ + \frac{Δ l}{λ} ) ) ) = 0.5 I ( 1 + A cos ( - 2 π ( τ \overline{v} + ϕ ) ) ) , \qquad ( 4 )$$

where φ is the normalized phase of the sinusoidal modulation of the source spectrum and Δl is the OPD in the interferometer. Equations (3) and (4) are similar, the only difference being in the last term, which in Equation (3) describes the time-dependent sinusoidal modulation of the signal due to the difference in the optical frequencies of the interfering beams while in Equation (4) it describes the modulation due to the phase of the spectral modulation.

In a conventional phase-shifting interferometer the value of φ in Equation (4) is constant in time (or changing in a controllable way to implement, for instance, phase-stepping algorithms). However, in a setup where the phase φ is constantly varying with time, the effect is functionally identical to that of heterodyne interferometry—that is, the output signal is modulated by a time-dependent cosine function the phase of which depends on the OPD. In particular, assuming that φ is a linear function of time, that is

φ=ft, (5)

where f is the frequency of phase (φ) change, then Equation (4) becomes

I(t)=0.5I(1+A cos(−2π(τv̅+ft+ψ))), (6)

which is identical in form to the basic heterodyne Equation (3).

Based on the foregoing, it is possible to implement a heterodyne detection scheme, with all its advantages, using SCI by introducing a time-varying (preferably, but not necessarily, linear) phase shift in the modulation of the source's spectrum. It is again worth noting that such manipulation of the spectrum does not cause any other changes in the fringe distribution in space (other than phase); in particular, the location of the envelope of fringes stays the same. This is an important feature of SCI because any change in the intensity of the output signal not attributed to the heterodyne signal would lower the measurement accuracy. In contrast, in conventional interferometry the change of fringe phase is typically done by altering the OPD between the interfering beams, e.g., by moving the position of the reference surface. This in turn shifts the location of the fringe envelope.

The implementation of spectrally-controlled heterodyne interferometry is therefore reduced to the means of introducing a continuously time-varying phase shift in the spectral domain. Two such embodiments of heterodyne SCI are described in U.S. Pat. No. 8,422,026. The present invention discloses a novel spectrally controllable source that is particularly suitable for producing the continuously time-varying phase shift in the spectral domain required for heterodyne SCI.

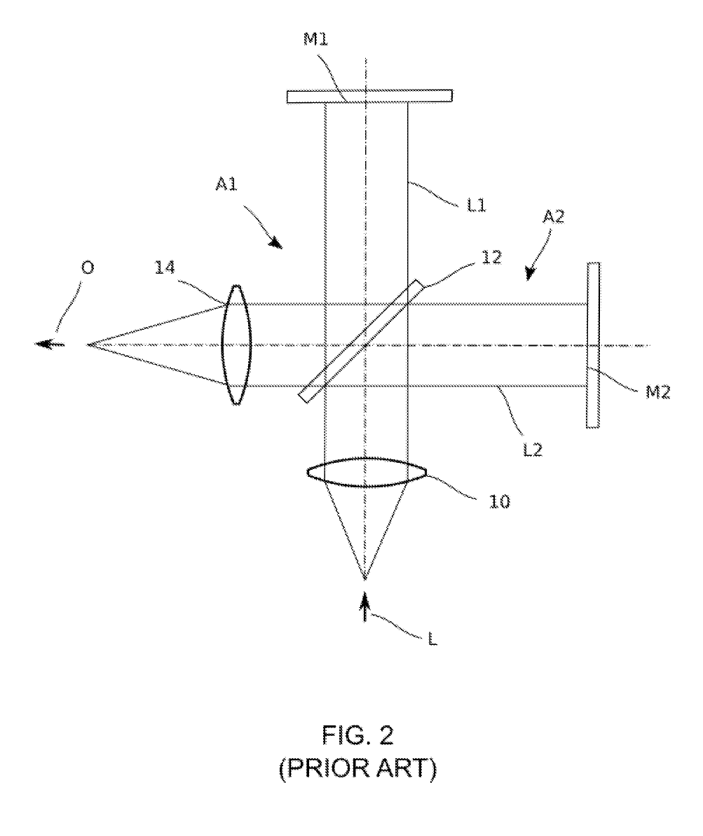

Referring to FIG. 2, it shows schematically a delay line in the form of a Twyman-Green interferometer, which is used throughout herein to describe the invention. Those skilled in the art will readily understand, though, that other delay-line configurations, such as in a Michelson interferometer, could be used as well. The Twyman-Green is a basic interferometer system where input light L collimated by appropriate optics 10 is split using a beam splitter 12 into two arms A1 and A2 with respective different paths L1 and L2. After reflecting from two mirrors M1 and M2, respectively, the beams are recombined and brought to interfere with each other for downstream processing of the output light O focusing through appropriate optics 14. Such system is commonly used with a laser source to measure displacements of one of the mirrors (distance measuring interferometry or DMI) or the shape of objects in surface metrology.

When used with a broadband source, the Twyman-Green interferometer can be used to generate a sinusoidal modulation of the spectrum, which is commonly referred to in the art as a channeled spectrum. This property can be utilized advantageously in practicing spectrally controlled interferometry because the time of flight difference between the arms A1 and A2 of the interferometer produces the sinusoidal modulation of the spectrum and the period of modulation corresponds to the distance between fringe peaks, which in turn corresponds to the difference in the optical paths of the interferometer's arms. Based on this realization, expressing Equation (3) above in terms of optical frequencies and distances rather than time, one obtains the following,

$$I ( t ) = 0.5 I ( 1 + A cos ( - 2 πτ \overline{v} ) ) = 0.5 I ( 1 + A cos ( \frac{- 2 π l \overline{v}}{c} ) ) , \qquad ( 7 )$$

where c is the speed of light and l is the optical path difference between the interferometer arms. Equation 7 shows that the basic Twyman-Green setup can be used to generate modulation that is useful for practicing SCI. A conventional scanning mechanism 16 is coupled to one of the mirrors to change the period of the sinusoidal modulation. Thus, the delay line in the interferometer amounts to a spectral modulator. However, it lacks the ability to shift the phase of spectral modulation as required to cause corresponding continuous phase shifts in the interferometric fringes, a critical requirement for heterodyne SCI. Any mechanical movement of either mirror M1 or M2 will also cause the period of spectral modulation to change, therefore introducing undesirable changes in an SCI device.

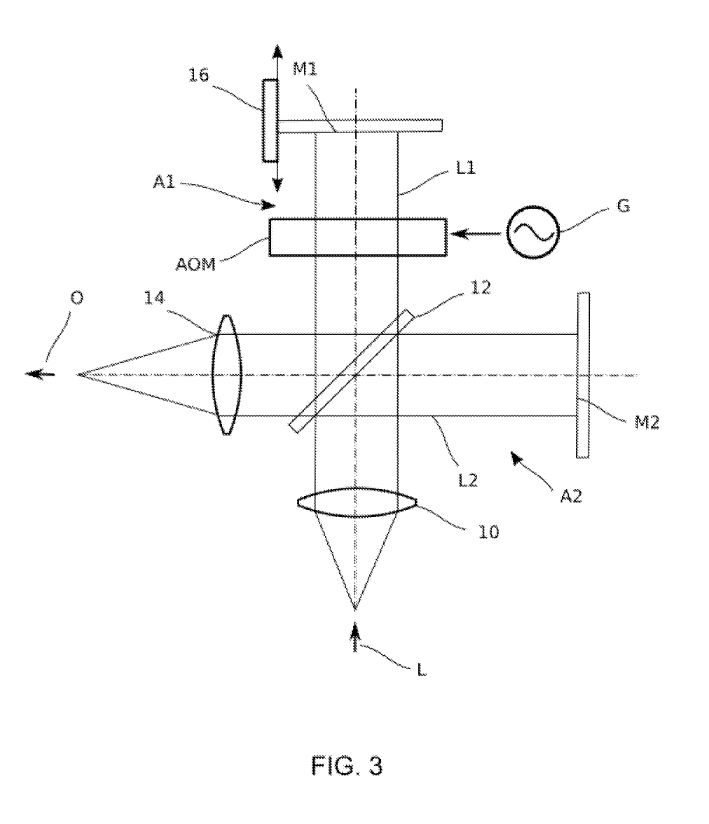

In particular with the objective of implementing SCI for heterodyne detection, a continuous phase shift in the spectral modulation is necessary. Therefore, according to the invention, an optical frequency shift is introduced in one of the arms of the Twymann-Green modulator; that is, the two arms of the delay line are caused to have slightly different frequencies, such that the recombined beams exhibit a heterodyne frequency without losing their relative correlation. This can be achieved, as shown for example in FIG. 3, by inserting an acousto-optic modulator (AOM) in the arm A1 to induce an optical frequency shift. Such devices are commonly used to introduce a heterodyne signal in distance measuring interferometers. Light passing through an AOM interacts with a running acoustic wave generated by the signal of a generator G resulting in the optical frequency that is shifted by the frequency of modulation of the acousto-optic device. In particular, volume gratings (Bragg gratings) formed by a running acoustic wave propagating in a suitable material are used for that purpose because they are characterized by high optical efficiency and stable frequency shifts on the order of several megahertz.

After passing through the AOM, the beam propagated in arm A1 is combined at beam splitter 12 and will interfere with the beam propagated in arm A2 that has not been frequency shifted but is delayed in time due to different optical paths of interferometer's arms. The combined beam, as previously shown, will have sinusoidal modulation of the spectrum and, due to the optical frequency difference between the beams, the spectral modulation phase will vary linearly in time with a period corresponding to the frequency of the shift introduced by the acousto-optic modulator. Based on Equation (3) above, this combined effect on the resulting irradiance as a function of time and optical frequency can be expressed as follows,

$$I ( t , v ) = 0.5 I ( 1 + A cos ( - 2 π ( \frac{l \overline{v}}{c} + Δ vt ) ) ) , \qquad ( 8 )$$

which demonstrates how the output beam O of FIG. 3 can be used to practice SCI and, in particular, it is particularly suitable for practicing the heterodyne version of spectrally controlled interferometry. Due to the sinusoidal modulation of the spectrum, when the output beam O is fed into a common-path interferometer (such as Fizeau), fringes are going to be visible at a distance l from the reference object, as explained in U.S. Pat. No. 8,422,026. At the same time, the frequency shift will induce continuous linear changes in the interference fringes, thus producing a true heterodyne beam suitable for heterodyne methods of analysis.

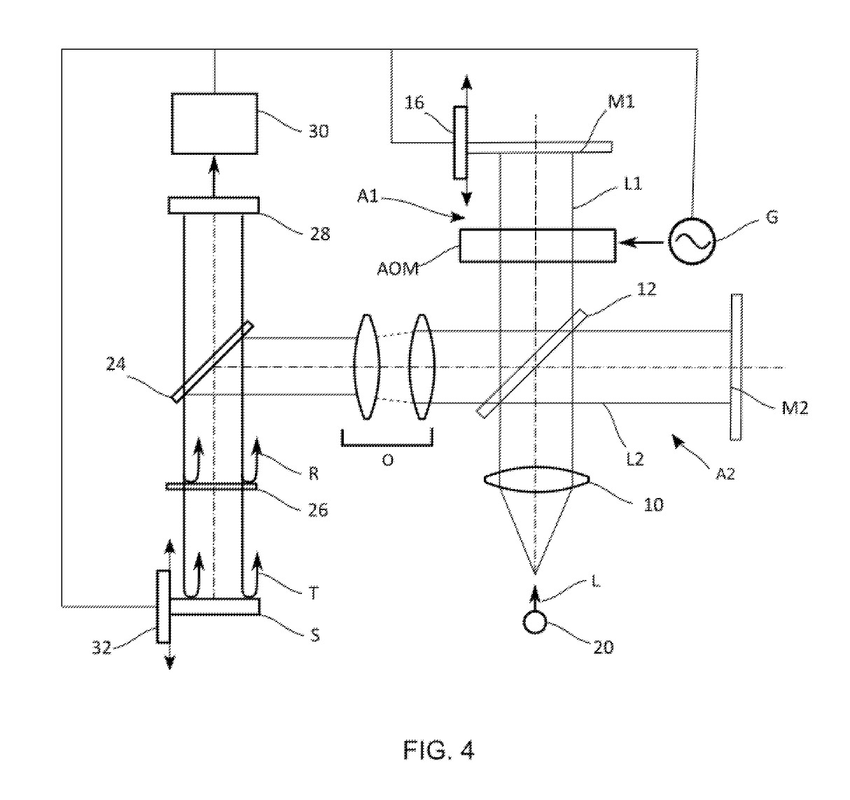

FIG. 4 illustrates the combination of the delay line of the invention with a Fizeau common-path interferometer. A white-light source 20 is preferably used with the modified Twyman-Green interferometer of FIG. 3 for producing the spectrally modulated output beam O that is fed through appropriate optics 22 into the Fizeau interferometer. The beam is reflected by a conventional beam-splitter 24 toward a transparent reference flat 26 and an axially aligned test surface S. Upon reflection of the light from each surface, a reference beam R and a test beam T are produced and returned on axis toward the beam-splitter 24. They are recombined, thereby producing interference, and are passed back through the beam-splitter to a detector 28 and processor 30 for recordation and analysis. Though not required for practicing SCI, a shifting mechanism 32 may be provided to shift the position of the test object (or the reference mirror) so that conventional phase-shifting measurements can be carried out, if desired. The processor 30 is connected in conventional manner to the scanner 16 to change the period of modulation in the delay line, to the generator G to change the frequency of modulation of the acusto-optical modulator AOM in the arm of the delay line, and to the shifting mechanism 32 of the Fizeau interferometer to practice conventional phase-shifting interferometry.

The embodiment of FIG. 4 illustrates the principle of operation of a heterodyne system in spectrally controlled interferometry according to the invention. Particular solutions may be more complex and optimized to fit specific problems, but the example disclosed above illustrates the key aspects of a heterodyne SCI design that is based on a truly heterodyne wavefront at the detector of the interferometer. The difference between what was disclosed in U.S. Pat. No. 9,618,320 and the present invention is that the patent teaches an approach whereby heterodyne processing methods can be utilized because the elements of a heterodyne front are simulated by modulating the light produced by a spectrally controlled source to introduce a time-varying phase shift in the spectral distribution. The embodiment of the present invention illustrated above, on the other hand, teaches an optical design that produces a spectrally controlled beam resulting from two beams that have been combined after inducing a slight frequency shift in one of them, in true heterodyne interferometric modality. The essence of the invention lies in the general idea of producing a spectrally modulated beam, splitting the beam into two beams, introducing a time-varying phase shift between the two beams by inducing a frequency shift in one of the beams, and recombining the beams, thereby obtaining a heterodyne front advantageously useful for SCI. The result at the detector is a pattern of interference fringes with a true heterodyne frequency localized in space according to SCI teachings. As those skilled in the art will readily understand, it is important to note here that the result of the superposition of multiple modulations, and/or modulation changes, and/or frequency shifts will be the same whether they occur sequentially, in any order, or contemporaneously. Therefore, the invention, as claimed, should be so construed.

Thus, the general concept of the invention has been illustrated by the combination of a white-light source with a delay line and the introduction of a frequency shift in one of the arms in the delay line. However, the scope of the invention is not limited to such embodiment because the same result can be achieved more generally by combining any spectrally controllable source, as herein defined, with any means for splitting the output of the source into two beams, such as with a conventional beam splitter, and with any means for inducing a frequency shift in one of the split beams. To that end, such spectrally controllable light source could be one of the spectrally controllable sources described in U.S. Pat. No. 8,810,884, herein incorporated by reference, or a source that comprises a conventional broadband source and a spectral modulator, as described in copending Ser. No. 15/806,717. Any such source combined with a beam splitter and a means for inducing a frequency shift in one of the split beams would be capable of producing a combined heterodyne wavefront suitable for practicing the invention. Therefore, as claimed, the scope of the invention should be so construed.

While the invention has been shown and described herein in what is believed to be the most practical and preferred embodiment, it is recognized that departures can be made therefrom within the scope of the invention. For example, the continuous linear phase shift in the spectral modulation produced by the delay line of the invention is preferred because of its simple implementation; however, it is understood that the invention could also be practiced with non-linear and/or discrete phase changes in the modulation of the spectrum so long as the corresponding phase shifts in the resulting interferometric fringes are suitable for interferometric analysis. Similarly, the delay line could be implemented with an interferometer of Michelson configuration as well as the Twyman-Green design described here. Therefore, the invention is not to be limited to the disclosed details but is to be accorded the full scope of the claims, including any and all equivalents thereof.

1. A method of producing heterodyne interferometric measurement signals for spectrally controlled interferometry:
providing a light source emitting a white light;
producing two beams from the white light emitted by said source;
introducing a frequency shift in one of said two beams;
spectrally modulating a combination of said two beams to produce a heterodyne beam with a varying spectral distribution; and
injecting said heterodyne beam into an interferometer.

2. The method of claim 1, wherein said frequency shift is produced by an acousto-optic modulator.

3. The method of claim 1, wherein said spectrally modulating step is carried out with a delay line configured to produce said varying spectral distribution.

4. The method of claim 3, wherein said delay line is configured as a Twyman-Green interferometer.

5. The method of claim 4, wherein said frequency shift is produced by an acousto-optic modulator in an arm of the Twyman-Green interferometer.

6. The method of claim 1, wherein said interferometer is a Fizeau interferometer.

7. The method of claim 1, further comprising the step of processing correlogram patterns produced by said varying spectral distribution with heterodyne interferometric analysis tools.

8. A source of heterodyne light for spectrally controlled interferometry comprising:
a spectrally controllable light source;
means for splitting light emitted by said spectrally controllable light source into two beams;
means for introducing a frequency shift in one of said two beams; and
means for recombining said two beams to produce a heterodyne wavefront.

9. The source of claim 8, wherein said means for introducing the frequency shift is an acousto-optic modulator.

10. The source of claim 8, wherein a combination of said spectrally controllable light source, said means for splitting light emitted by the spectrally controllable light source into two beams, and said means for recombining the two beams is implemented by optically coupling a white-light source with a delay line.

11. The source of claim 10, wherein said means for introducing the frequency shift is an acousto-optic modulator.

12. The source of claim 10, wherein said delay line is configured as a Twyman-Green interferometer.

13. The source of claim 10, wherein said delay line is configured as a Twyman-Green interferometer and said means for introducing a frequency shift is an acousto-optic modulator in an arm of the Twyman-Green interferometer.

14. The source of claim 8, further including an interferometer adapted to receive said heterodyne wavefront.

15. The source of claim 14, wherein said interferometer is a Fizeau interferometer.

16. An interferometric system for spectrally controlled heterodyne interferometry comprising:
a white-light source;
a delay line in Twyman-Green configuration optically coupled to the white-light source;
an acousto-optic modulator adapted to introduce a frequency shift in a beam traveling in an arm of the delay line; and
a Fizeau interferometer adapted to receive a heterodyne beam with a varying spectral distribution emitted by the delay line.
